(19) United States
(12) Patent Application Publication
(10) Pub. No.: US 2026/0304579 A1
(43) Pub. Date: Oct. 1, 2026

(54) DYNAMIC MOTORLESS LIGHTING MODULE FOR EMULATING NATURAL LIGHT EFFECTS

(71) Applicant: KROBOX SDN BHD, Kuala Lumpur (MY)

(72) Inventors: Siang Pheng Ong, Kuala Lumpur (MY); Lee Shyuan Heng, Kuala Lumpur (MY); Zi Yuan Ko, Kuala Lumpur (MY)

(21) Appl. No.: 19/633,734

(22) Filed: Mar. 30, 2026

(30) Foreign Application Priority Data
Mar. 28, 2025 (MY) PI 2025001975
May 2, 2025 (SG) 10202501135R

(51) Int. Cl. H05B 47/165; F21V 5/00; F21V 9/02; F21V 23/00; F21Y 115/10; H05B 45/10; H05B 45/20; H05B 45/59; H05B 47/11; H05B 47/16; H05B 47/17; H05B 47/175

(52) U.S. Cl. CPC H05B 47/165; F21V 5/002; F21V 9/02; F21V 23/005; H05B 45/10; H05B 45/20; H05B 45/59; H05B 47/11; H05B 47/16; H05B 47/17; H05B 47/196; F21Y 2115/10

(57) ABSTRACT

The present invention relates to a motorless lighting system (100) for replicating natural light effects, comprising a circuit board (200) with an embedded microcontroller programmed with a firmware algorithm for controlling light transition, brightness levels, and dimming effect for emulating natural lighting, one or more light-emitting diodes (LED) (400) is arranged in multiple channels and integrated with the circuit board (200) for emitting lights and one or more lenses (300) positioned for shaping, focusing, scattering the emitted lights, and controlling shadow formation and effects. Characterised in that, the firmware algorithm calculates the transition times and fade effects for the LED (400) for maintaining a gentle, organic flow, preventing abrupt changes and replicates natural phenomena, wherein the use of the firmware algorithm eliminates the need for a motor or mechanical components by digitally controlling the light path, focus, and scatter effects.

### FIELD OF INVENTION

The present invention generally relates to a lighting system that replicates natural light effects. Specifically, the present invention relates to a motorless lighting system that replicates natural light effects such as a dappled moonlight and water ripples for ensuring silent operation and extended durability.

### BACKGROUND OF THE INVENTION

A lighting system that replicates natural light effects is designed to simulate various atmospheric conditions, such as dappled moonlight filtering through trees or the rippling reflections of water. These systems typically use mechanical components, such as rotating filters, patterned lenses, or motorized gobo wheels, to create dynamic lighting patterns. They are widely used in theatrical productions, themed environments, architectural lighting, and immersive art installations to enhance realism and ambiance.

One of the key advantages of using a mechanically-driven lighting system is its ability to produce realistic, organic lighting effects without requiring complex digital programming. The physical components create smooth, natural-looking patterns that closely resemble real-world light interactions. Additionally, these systems are often more cost-effective than fully digital alternatives, as they rely on traditional motors and mechanical parts rather than advanced projection technology. Their reliability in fixed installations, such as theme parks and museums, makes them a preferred choice for creating an engaging atmosphere.

Despite their effectiveness, mechanical lighting systems have several drawbacks. The use of motors and moving parts generates noise, which can be disruptive, particularly in quiet environments such as museums or high-end architectural settings. Additionally, continuous operation leads to wear and tear, causing components to degrade over time and increasing the need for maintenance and replacements. These systems also consume more energy than their static or digital counterparts, as the additional mechanical movement requires extra power. Furthermore, installation can be complex due to the bulkiness of the components, making it challenging to integrate seamlessly into certain spaces. While these factors may present limitations, they must be weighed against the benefits of achieving highly realistic and immersive natural light effects.

A European patent EP4205511B1 has disclosed a dapple lighting system that renders a realistic view of the sky by generating natural-looking patterns, vertical lighting dynamics, and shadow patterns. This is achieved through a combination of randomly operated low-intensity LEDs and controlled high-intensity LEDs in a 3:1 ratio. While this system effectively simulates dappled light effects, it relies on a structured LED arrangement and control mechanisms, which introduce complexity and potential limitations in achieving seamless natural light replication without electronic modulation.

Similarly, a European patent application EP3370104A1 presents a sunlight-imitating lighting system that utilizes a collimation and homogenization unit to generate directed, non-diffused light along a specific beam direction. While this approach enhances light uniformity and diffusion control, it is primarily designed to replicate general sunlight characteristics rather than dynamic, naturally occurring light effects such as water ripples or dappled moonlight. The system's reliance on an optical homogenization process limits its adaptability for producing organic light patterns without preconfigured diffusion.

Meanwhile, a United States patent U.S. Pat. No. 9,781,779B2 discloses an LED light fixture with background lighting that arranges light sources in two controllable groups. By integrating diffusing and non-diffusing regions, the system eliminates the dotted appearance of LEDs and allows for colour variations. However, its primary focus is on background illumination and aesthetic lighting rather than accurately replicating natural light effects in a physically dynamic manner. The system remains dependent on electronic control, lacking a mechanism for producing authentic, naturally occurring light variations without programmed adjustments.

Several prior art solutions anticipate variations of the features of the proposed invention. However, the utilization of the proposed invention offers novelty and inventiveness by featuring a motorless lighting system that is able to replicate natural light effects through the integration of LEDs, lenses, and software control. By eliminating mechanical components, the system operates silently, enhancing user experience in quiet environments while also reducing energy consumption through optimized LED arrays that minimize power usage and heat generation. Additionally, the absence of moving parts enhances durability by preventing mechanical wear and tear, thereby extending the system's operational lifespan. The proposed invention also achieves highly dynamic light effects, such as moonlight dappling and water ripples, through advanced firmware algorithms that seamlessly adjust light intensity, speed, and patterns. Furthermore, the system is designed for easy installation, allowing discreet integration into various settings without the bulk associated with traditional motor-driven lighting systems.

### SUMMARY OF THE PRESENT INVENTION

The present invention features a motorless lighting system for replicating natural light effects, comprising a circuit board with an embedded microcontroller programmed with a firmware algorithm for controlling light transition, brightness levels, and dimming effect for emulating natural lighting, one or more light-emitting diodes (LED) is arranged in multiple channels and integrated with the circuit board for emitting lights and one or more lenses positioned for shaping, focusing, and scattering the emitted lights. Characterised in that, the firmware algorithm calculates the transition times and fade effects for the LED for maintaining a gentle, organic flow, preventing abrupt changes and replicates natural phenomena, wherein the use of the firmware algorithm eliminates the need for a motor or mechanical components by digitally controlling the light path, focus, and scatter effects.

Preferably, the circuit board is a printed circuit board.

Preferably, the firmware algorithm controls multiple LED channels to create a gradual transition between different lighting intensities and colours.

Preferably, the firmware algorithm has calculated the transition between brightness levels to prevent abrupt changes, ensuring a seamless and realistic lighting effect.

Preferably, the firmware algorithm automatically adapts to ambient lighting conditions to maintain a consistent visual experience.
the light transitions and dimming effects are customisable based on user preferences or pre-programmed settings.

Preferably, the LED are arranged to produce overlapping light and shadow patterns, enhancing the realism of the lighting effect.

Preferably, the lenses have a primary lens for dispersing the light uniformly for diffusion or collimation

Preferably, the lenses have a secondary lens for transmitting the light through a patterned and contoured surface for creating the desired natural effects.

Preferably, the distance between the lenses is crucial to produce a good natural light effect

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE DRAWINGS

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings in which:

FIG. 1 illustrates the motorless lighting system with a secondary lens featuring a waving pattern surface.

FIG. 2 illustrates the motorless lighting system with a secondary lens featuring a rough surface.

FIG. 3 illustrates the circuit board with LED arranged in a circular shape to create a dapple effect.

FIG. 4 illustrates the circuit board with LED arranged in a linear shape to create a ripple effect.

### REFERENCE NUMERALS

100: motorless lighting system
200: circuit board
300: lenses
310: primary lens
320: secondary lens
400: Light-Emitting Diode (LED)

### DETAILED DESCRIPTION OF THE INVENTION

In the following detailed description, numerous specific details are set forth to provide a thorough understanding of the invention. However, it will be understood by those skilled in the art that present invention may be practiced without these specific details. In other instances, well known method, procedures, and components have not been described in details so as not to obscure the present invention.

The general principles of the present invention relates to a motorless lighting system (100) for replicating natural light effects, comprising a circuit board (200) with an embedded microcontroller programmed with a firmware algorithm for controlling light transition, brightness levels, and dimming effect for emulating natural lighting, one or more light-emitting diodes (LED) (400) is arranged in multiple channels and integrated with the circuit board (200) for emitting lights and one or more lenses (300) positioned for shaping, focusing, scattering the emitted lights and controlling shadow formation and effects. Characterised in that, the firmware algorithm calculates the transition times and fade effects for the LED (400) for maintaining a gentle, organic flow, preventing abrupt changes and replicates natural phenomena, wherein the use of the firmware algorithm eliminates the need for a motor or mechanical components by digitally controlling the light path, focus, and scatter effects.

Preferably, this present invention relates to a motorless lighting system (100) that replicates natural light effects for ensuring silent operation and extended durability.

Preferably, the natural light effects is a dappled moonlight, a water ripples, a fire glow, a candle flame, a swaying trees, an ocean waves, a rippling light, and a dappling effects.

Most preferably, this present invention relates to a motorless lighting system (100) designed to replicate natural light effects without using mechanical components. This ensures silent operation, enhanced durability, and lower energy consumption. The system's core components work together to achieve realistic lighting effects such as dappled moonlight, water ripples, and soft natural transitions.

In general, the motorless lighting system (100) is designed to replicate natural light effects through the seamless integration of its components. At its core, a circuit board (200) houses an embedded microcontroller programmed with a firmware algorithm that governs the entire lighting operation. This firmware precisely calculates light transitions, brightness levels, and dimming effects, ensuring smooth and gradual changes that mimic natural lighting phenomena. The system incorporates multiple light-emitting diodes (LED) (400), each arranged in separate channels on the circuit board. These LED (400) work in synchronization under the control of the firmware to create overlapping light and shadow effects, enhancing realism. Additionally, one or more lenses (300) are positioned to shape, focus, and scatter the emitted light, further refining the light distribution. By utilizing a firmware-driven approach, the system eliminates the need for motors or mechanical components, instead relying on software-controlled adjustments to achieve dynamic lighting effects. This integration results in a natural, fluid lighting experience that seamlessly transitions between different intensities and patterns without abrupt changes, making it both efficient and aesthetically effective.

Further explanation of each feature will be explained below:

### Circuit Board (200) and Embedded Microcontroller

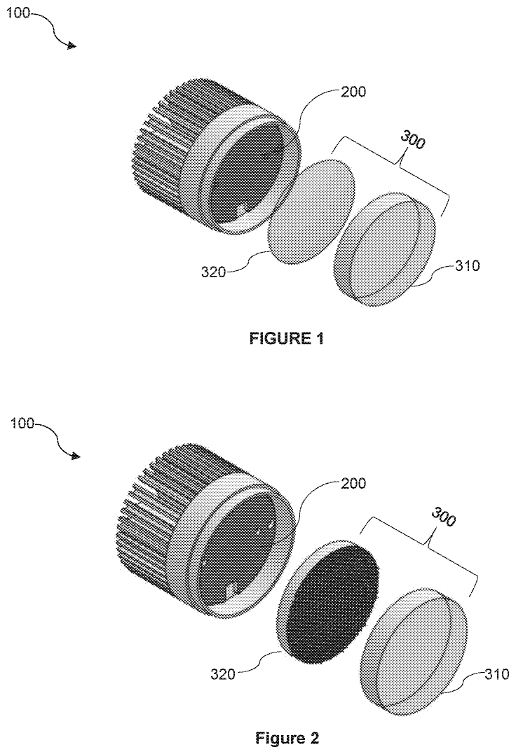

As shown in FIGS. 1 and 2 the circuit board (200) is the foundational structure that holds and connects all the system's components, wherein it consists of a series of conductive pathways that enable the transmission of electrical signals to travel between the microcontroller, LED (400), power supply, and other electronic elements. The design of the circuit board (200) ensures stable signal transmission, prevents power fluctuations, and optimizes energy efficiency. Further, it also provides thermal management features to prevent overheating, ensuring long-term reliability.

Preferably, the circuit board (200) can be a printed circuit board (PCB), wherein the PCB is preferably used for its durability and ability to accommodate complex circuitry in a compact space.

Additionally, the microcontroller is the processing unit embedded onto the circuit board (200), acting as the brain of the lighting system. It is responsible for executing the firmware algorithm and sending precise instructions to the LED (400). These microcontrollers are energy-efficient and capable of handling real-time processing for smooth lighting transitions. They interpret the firmware's instructions and adjust the brightness, colour temperature, and dimming sequences of the LED (400) accordingly.

Preferably, the microcontroller is a memory-integrated microcontroller.

### Firmware Algorithm

The firmware algorithm is the embedded software within a microcontroller that controls every aspect of the lighting system. Unlike traditional setups that rely on external control units or mechanical dimmers, this system uses predefined programming to dynamically adjust the light output. The algorithm continuously monitors and adjusts fade times, brightness levels, and transitions to deliver a seamless lighting experience.

Specifically, the firmware mimics natural lighting effects by gradually increasing or decreasing brightness over a calculated time frame, ensuring smooth and organic changes that avoid sudden or harsh transitions. By calculating the changes between brightness levels, the system ensures that the lighting effect remains realistic and uninterrupted.

In addition, the firmware dynamically simulates natural phenomena such as sunrise and sunset by controlling the LED (400) brightness, and it manages multiple LED channels to produce gradual transitions between various intensities and colours. Moreover, the firmware automatically adapts to ambient lighting conditions to maintain a consistent visual experience, while allowing the light transitions and dimming effects to be customized based on user preferences or pre-programmed settings.

### Light-Emitting Diodes (LED) (400) Arranged in Multiple Channels

This present invention utilizes one or more light-emitting diodes (LED) (400) as the primary source of illumination, wherein the LED are arranged in separate channels, which are controlled individually by the microcontroller. By dividing the LED (400) into different channels, the firmware can precisely adjust the brightness of each group, allowing for layered lighting effects. Preferably, this multi-channel approach enables the creation of overlapping light and shadow patterns, which contribute to a more natural and dynamic lighting experience.

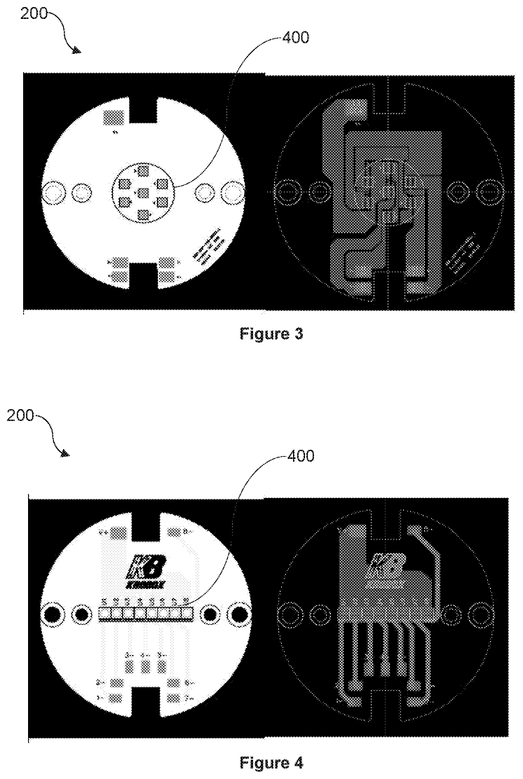

Preferably, the multi-channel can be arranged in different shapes to produce various light patterns. For example, arranging the LED (400) in a circular shape creates a dapple effect, as shown in FIG. 3, while arranging them in a linear shape produces a ripple effect.

Preferably, the LED (400) is arranged in separate channels for providing the primary source of light, enhancing certain areas with softer or light colours and for assisting in blending light changes smoothly. Further, this multi-channel control allows for gradient lighting, wherein the brightness levels can gradually change across a surface for creating depth and realism, which has eliminated harsh lighting boundaries and enhanced the perception of natural light movement.

### Lenses (300)

The lenses (300) as shown in FIGS. 1 and 2 play a crucial role in directing and shaping the light emitted by the LED (400), wherein the lenses (300) will determine how light is focused, scattered, or diffused for enhancing the overall lighting effect. Additionally, the lenses (300) can influence shadow formation, controlling the sharpness, softness, or diffusion of shadows depending on the lenses (300) and effects setup. Preferably, the selection of lenses (300) depends on the desired lighting application, whether it requires a narrow spotlight, wide floodlight, or soft ambient glow.

Preferably, the lenses (300) type can be a convex lens, a Fresnel lens, or a diffuser lens.

Preferably, the present invention uses a dual lens system for controlling the light ray path, focusing, and scattering, enhancing the versatility of the light effects.

Most preferably, the lenses (300) comprise a primary lens (310) and a secondary lens (320). Preferably, the primary lens (310) is used for dispersing the light uniformly for diffusion or collimation and preferably, the secondary lens (320) is used for transmitting the light through a patterned and contoured surface for creating the desired natural effect.

Preferably, the pattern of the surface can be designed in various ways to optimize the desired effect. For instance, the surface may feature a waving pattern or be intentionally rough. Other examples include ribbed, dimpled, honeycombed, etched, or contoured textures. Each of these patterns influences the way light is transmitted through the lens, allowing for finely tuned control over light dispersion and the creation of unique, customizable lighting effects.

As an example, the waving pattern surface lens has been used for producing a dapple effect as shown in FIG. 1, and the rough surface lens has been used for producing a ripple effect as shown in FIG. 2.

Consequently, the distance between these lenses (300) is crucial, as it must be optimized to produce a balanced and natural light effect.

Preferably, different lens distances will produce different effects.

Based on tables 1 and 2 below, the applicant has conducted an experiment to show how the distance between the lenses (300) will produce the different dapple effect. Preferably, the dapple effect is influenced by the distance between lenses (300). In Table 1, it shows the distance from the primary lens (310) to the LED (400), wherein the varying distance affects how light spreads and merges. If the primary lens (310) is too close to the LED (400) (less than 20 mm), the light spreads quickly, resulting in a wide-angle effect where patterns overlap. At an optimal distance of 20 mm, the light blends smoothly, allowing patterns to merge naturally without excessive overlap. However, if the lenses (300) are positioned too far from the LED (400) (greater than 20 mm), the projection becomes sharper, with distinct LED spots forming a more defined pattern.

In Table 2, it shows the distance between the primary lens (310) and the secondary lens (320), the distance also plays a crucial role in shaping the final dapple effect. When the primary lens (310) and the secondary lens (320) are at an optimal distance of 0 mm, the result is a soft and evenly distributed pattern with a natural flow. However, increasing the distance beyond 0 mm leads to a more concentrated center with noticeable bright spots, creating a less uniform spread. Hence, the applicant arrived to the conclusion that the distance between the lenses (300) and the LED (400) is important to achieve the desired dapple effect.

TABLE 1
Distance between primary lens with LED for dapple effect

| Distance of | | |
|---|---|---|
| primary lens | Distance | |
| and LED | Range | Effect Description |
| Closer | <20 mm | Creates a wide-angle effect, where light |
| | | spreads out quickly, causing patterns to |
| | | overlap. |
| Optimal | 20 mm | Achieves a balanced blend of light, |
| | | allowing patterns to merge smoothly and |
| | | naturally. |
| Farther | >20 mm | Produces a sharper projection with distinct |
| | | LED spots, forming a more defined pattern. |

TABLE 2
Distance between the lenses for dapple effect

| Distance between | Distance | |
|---|---|---|
| the lenses | Range | Effect Description |
| Optimal | 0 mm | Delivers a soft and evenly distributed |
| | | pattern with a natural flow. |
| Farther | >0 mm | Forms a concentrated center with |
| | | noticeable bright spots, creating a less |
| | | uniform spread. |

Further, the applicant also experimented with the ripple effect to see how the distances between the lenses (300) and LED (400) play a crucial role in shaping the final ripple effect, and the result is shown in Tables 3 and 4. Preferably, the ripple effect is influenced by the positioning of lenses (300), impacting how light waves spread and interact. In Table 3, it shows the distance from the primary lens (310) to the LED (400), wherein the different distances result in varying ripple characteristics. If the primary lens (310) is placed too close to the LED (400) (less than 15.5 mm), the light expands rapidly, causing the waves to blend and reducing overall contrast. At the optimal distance of 15.5 mm, the light is controlled effectively, creating a well-defined and natural ripple effect. However, if the primary lens (310) is positioned too far from the LED (400) (greater than 15.5 mm), the ripple effect becomes more pronounced with sharper edges and a more segmented appearance due to increased contrast.

Table 4 shows the distance between the primary lens (310) and the secondary lens (320), wherein the distance continues to influence the final ripple pattern. If the lenses (300) are too close (less than 10.5 mm), the pattern becomes dense with darker voids, resulting in a more dramatic and textured effect. When the lenses (300) are positioned at the optimal distance of 10.5 mm, the transition between ripples is smooth, maintaining a balanced sharpness with a natural gradient. However, increasing the distance beyond 10.5 mm narrows the beam angle, making the ripple effect appear tighter and more focused, which can alter the overall visual impact. The precise placement of lenses (300) is crucial in achieving the desired ripple effect with the right balance of contrast and definition.

TABLE 3
Distance between primary lens with LED for ripple effect

| Distance of | | |
|---|---|---|
| primary lens | Distance | |
| and LED | Range | Effect Description |
| Closer | <15.5 mm | Expands the pattern quickly, blending |
| | | waves together and reducing contrast. |
| Optimal | 15.5 mm | Spreads light in a controlled manner, |
| | | forming a well-defined and natural ripple |
| | | effect. |
| Farther | >15.5 mm | Produces a high-contrast ripple with |
| | | sharper edges and a more segmented |
| | | appearance. |

TABLE 4
Distance between the lenses for ripple effect

| Distance between | Distance | |
|---|---|---|
| the lenses | Range | Effect Description |
| Closer | <10.5 mm | Forms a dense pattern with darker voids, |
| | | creating a more dramatic texture. |
| Optimal | 10.5 mm | Achieves a smooth transition with |
| | | balanced sharpness and a natural gradient. |
| Farther | >10.5 mm | Narrows the beam angle, making the |
| | | ripple effect appear tighter and more |
| | | focused. |

By combining these specific lenses (300) types with a multi-channel LED system, a highly customizable lighting effect is achieved without the need for physical repositioning of bulbs or reflectors. Instead, the system relies entirely on the firmware algorithm, the lenses (300), and the LED (300), thereby reducing the reliance on mechanical components and enhancing overall versatility.

Preferably, the traditional dynamic lighting systems often rely on motors or moving reflectors to achieve similar effects. These mechanical components introduce several drawbacks, including noise, wear and tear, and increased energy consumption. By contrast, this system eliminates the need for any physical movement, relying solely on precise digital control to achieve seamless and silent lighting transitions.

In conclusion, each component or feature of this present invention plays a crucial role in delivering a smooth, natural, and customizable lighting experience. The circuit board provides a stable foundation, while the embedded microcontroller processes real-time lighting adjustments. The firmware algorithm replaces mechanical components by dynamically controlling LED (400) transitions, and multi-channel LEDs allow for layered lighting effects, enhancing realism. Lenses refine the light's focus and dispersion, eliminating harsh lighting boundaries. Most importantly, the system's motorless operation makes it energy-efficient, durable, and maintenance-free, offering superior performance over traditional motor-based lighting systems. This advanced integration of electronics, optics, and software-driven control makes the lighting system highly adaptable, making it suitable for applications such as smart homes, architectural lighting, theatres, automotive lighting, and industrial environments where precise and natural lighting effects are required.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. A motorless lighting system (100) for replicating natural light effects, comprising:
a circuit board (200) with an embedded microcontroller programmed with a firmware algorithm for controlling light transition, brightness levels, and dimming effect for emulating natural lighting;
one or more light-emitting diodes (LED) (400) is arranged in multiple channels and integrated with the circuit board (200) for emitting lights;
one or more lenses (300) positioned for shaping, focusing, scattering the emitted lights, and controlling shadow formation and effects; and
characterised in that, the firmware algorithm calculates the transition times and fade effects for the LED (400) for maintaining a gentle, organic flow, preventing abrupt changes and replicates natural phenomena, wherein the use of the firmware algorithm eliminates the need for a motor or mechanical components by digitally controlling the light path, focus, and scatter effects.

2. The motorless lighting system (100) for replicating natural light effects according to claim 1, wherein the circuit board (200) is a printed circuit board.

3. The motorless lighting system (100) for replicating natural light effects according to claim 1, wherein the firmware algorithm controls multiple LED channels to create a gradual transition between different lighting intensities and colours.

4. The motorless lighting system (100) for replicating natural light effects according to claim 1, wherein the firmware algorithm has calculated the transition between brightness levels to prevent abrupt changes, ensuring a seamless and realistic lighting effect.

5. The motorless lighting system (100) for replicating natural light effects according to claim 1, wherein the firmware algorithm automatically adapts to ambient lighting conditions to maintain a consistent visual experience.

6. The motorless lighting system (100) for replicating natural light effects according to claim 1, wherein the light transitions and dimming effects are customisable based on user preferences or pre-programmed settings.

7. The motorless lighting system (100) for replicating natural light effects according to claim 1, wherein the LED (400) are arranged to produce overlapping light and shadow patterns, enhancing the realism of the lighting effect.

8. The motorless lighting system (100) for replicating natural light effects according to claim 1, wherein the lenses (300) have a primary lens (310) for dispersing the light uniformly for diffusion or collimation

9. The motorless lighting system (100) for replicating natural light effects according to claim 1, wherein the lenses (300) have a secondary lens (320) for transmitting the light through a patterned and contoured surface for creating the desired natural effects.

10. The motorless lighting system (100) for replicating natural light effects according to claim 1, wherein the distance between the lenses (300) is crucial to produce a good natural light effect.

11. A motorless lighting system (100) for generating dynamic natural light effects, comprising:
a circuit board (200) with an embedded microcontroller;
one or more light-emitting diodes (LED) (400) arranged in multiple channels and electrically coupled to the circuit board (200);
one or more lenses (300) positioned to shape, focus, or scatter light emitted from the LED (400); and
a firmware algorithm executed by the microcontroller and configured to control light transitions, brightness levels, and dimming effects to replicate natural lighting phenomena without the use of motors or mechanical components.

12. The motorless lighting system (100) according to claim 11, wherein the firmware algorithm dynamically adjusts the speed, timing, and progression of lighting transitions to emulate different natural lighting phenomena.

13. The motorless lighting system (100) according to claim 11, wherein the microcontroller performs real-time calculations to synchronize multiple LED (400) channels for producing layered and coordinated lighting effects.

14. The motorless lighting system (100) according to claim 11, wherein the firmware algorithm includes a flicker-suppression routine configured to prevent visible artifacts during brightness transitions.

15. The motorless lighting system (100) according to claim 11, wherein each LED (400) channel is individually addressable to enable selective activation for generating localized variations in shadow formation.

16. The motorless lighting system (100) according to claim 11, wherein the secondary lens (320) comprises a patterned surface selected from ribbed, dimpled, honeycombed, etched, contoured, rough, or waving textures for modifying the resulting natural light effect.

17. The motorless lighting system (100) according to claim 11, wherein the circuit board (200) includes an integrated thermal management structure configured to dissipate heat and prevent overheating during prolonged operation.

18. The motorless lighting system (100) according to claim 11, wherein the firmware algorithm includes a mode for simulating cyclical natural events, including sunrise, sunset, shifting cloud cover, or gradual moonlight variation.

19. The motorless lighting system (100) according to claim 11, wherein the distance between the primary lens (310) and the LED (400) is adjustable to allow user-defined tuning of the dapple or ripple effect.

20. The motorless lighting system (100) according to claim 11, wherein the system comprises a user interface configured to select between multiple pre-programmed natural lighting profiles.
